(19) United States
(12) Patent Application Publication
(10) Pub. No.: US 2013/0200296 A1
(43) Pub. Date: Aug. 8, 2013

(54) POLYMER NANOCOMPOSITE CONTAINING GLASS FIBER COATED WITH METAL-CARBON NANOTUBE AND GRAPHITE AND METHOD OF PREPARING THE SAME

(71) Applicants: Kyong Hwa Song, Seoul (KR); Byung Sam Choi, Gunpo (KR)

(72) Inventors: Kyong Hwa Song, Seoul (KR); Byung Sam Choi, Gunpo (KR)

(73) Assignee: HYUNDAI MOTOR COMPANY, Seoul (KR)

(21) Appl. No.: 13/443,214

(22) Filed: Apr. 10, 2012

(30) Foreign Application Priority Data
Feb. 7, 2012 (KR) 10-2012-0012484

(51) Int. Cl. C09K 5/00; B29C 43/00; B82Y 30/00; B82Y 40/00

(52) U.S. Cl. 252/74; 264/134; 977/742; 977/750; 977/752; 977/900

(57) ABSTRACT

The present disclosure relates to a polymer nanocomposite including a metal-carbon nanotube coated glass fiber and graphite, in which a metal-carbon nanotube coated glass fiber serving as an electromagnetic wave shielding material is hybridized with graphite having an excellent heat conductivity, thereby improving the electromagnetic wave shielding performance in a low frequency range. The polymer nancomposite according to the disclosure is broadly applicable to a variety of fields requiring electromagnetic wave shielding performance such as, for example, various electronic component housings for a vehicle, components of an electric vehicle, a mobile phone, and a display device, and a method of preparing the polymer nanocomposite.

### CROSS-REFERENCE TO RELATED APPLICATION

This application claims under 35 U.S.C. §119(a) the benefit of Korean Patent Application No. 10-2012-0012484 filed on Feb. 7, 2012, the entire contents of which are incorporated herein by reference.

### BACKGROUND

(a) Technical Field

The present invention relates to a polymer nanocomposite material with an improved electromagnetic wave shielding performance. More particularly, the present invention relates to a polymer nanocomposite material containing a metal-carbon nanotube coated glass fiber and graphite, in which the metal-carbon nanotube coated glass fiber serving as an electromagnetic wave shielding material is hybridized with graphite having an excellent heat conductivity, thereby improving the electromagnetic wave shielding performance in a low frequency area and being useful for various application fields requiring electromagnetic wave shielding performance, such as housings of various electronic components of a car, components of an electric car, a mobile phone, and a display device, and a method of preparing the same.

(b) Background Art

It is known that harmfulness of electromagnetic waves represents a serious threat to the development of a variety of technologies such as, for example, information and communication technologies, computer technologies, automotive technologies, and the like. For example, the malfunction of a radio communication apparatus by the generation of unnecessary electromagnetic waves may cause a serious danger to both the safety of the electronic devices themselves, and the safety of the individual people who depend on the communication apparatus. In a car, it is important to have electromagnetic wave shielding for a wide frequency range from about 0.15 MHz to about 2.5 GHz. In particular, interference between electronic components caused by the rapid increase in the use of electronic devices, and noise created due to the use of high frequencies, may negatively affect the function of other components in the vehicle, thereby causing an accident. Accordingly, electromagnetic wave shielding is very important for a variety of applications.

Most currently used electronic component housings are made of metal having a good conductivity, and most electromagnetic waves are reflected by the metal surface to be shielded. However, the reflected electromagnetic waves may affect adjacent devices, thereby causing another problem.

In the case of a product made of a plastic material, the problem of electromagnetic waves has typically been solved by coating the plastic or plating the plastic with a conductive material by an electroless method to provide electromagnetic wave shielding. Disadvantageously, the attachment/removal of the coated paint and the use of an electrolysis solution in the above process cause significant environmental problems. However, as a result of the expansion of the use of electronic devices in cars and the rapid supply of mobile displays, there has been an increased demand for plastic electronic components in order to meet the design demands for compact electronic components. Accordingly, there has been continuous demand to replace metal electronic components with plastic electronic components because plastic is light and easily fabricated into various shapes. Consequently, the number of components made of plastic is expected to increase substantially in the future. Unfortunately, this trend faces a serious problem: plastic does not have the conductivity of the metal, so it is impossible to use plastic for a housing material for an electronic component that requires electromagnetic wave shielding.

In order to solve the drawback, research has been conducted to develop a method of preparing a composite by adding a filler having excellent conductivity. According to a principle mechanism of shielding an electromagnetic wave in a polymer containing a conductive filler, when the electromagnetic wave meets a new medium surface while being transferred through air, some electromagnetic waves are reflected and the remaining electromagnetic waves are bent and transmitted. In this event, when the electromagnetic waves meet a conductive nano material inside the new medium, multi-reflection or absorption of the electromagnetic waves is created, so that the electromagnetic waves are weakly changed or dissipated, or some of the electromagnetic waves are transmitted. In other words, the electromagnetic waves dissipate while being multi-reflected and absorbed by an interior filler in the polymer composite. The absorbed electromagnetic waves are changed to heat, which is gradually discharged from the component while moving along a network of the filler. Accordingly, in order to shield the electromagnetic waves, the composite should ultimately contain both a material with a good electrical conductivity and a material with a good heat transfer property.

According to the aforementioned principle, the electromagnetic wave shielding of plastic typically employs a method of dispersing at least 30 vol % of a metal powder having excellent electrical conductivity throughout the plastic, or by using carbon fibers in a polymer, such as silicon rubber, polyurethane, polycarbonate, and epoxy resin.

In order to comply with the electromagnetic wave shielding standards, which recently have recently become quite strict, it is now necessary to achieve a lower volume resistivity and a high shielding effect. To this end, it is necessary to disperse a larger quantity of metal powder in the polymer. However, when such a large quantity of silver powder is dispersed in the polymer, the electromagnetic wave shielding effect may be improved by the improvement of the electrical conductivity, however, the mechanical properties of the material, such as impact strength is degraded. Consequently, there are many significant limitations in the application of a metal powder as an electromagnetic wave shielding material.

As an alternative, it has been suggested that a carbon nanotube may be used as an electromagnetic wave shielding material. Carbon nanotube is a material having a shape of an elongated tube made of carbon atoms and having a nano diameter, an electrical conductivity 1000 times higher than that of copper, a high strength and modulus of elasticity corresponding to 100 times that of steel, and a high aspect ratio of a length to a diameter.

Accordingly, the polymer composite, in which the carbon nanotube is dispersed in a polymer matrix, has been noted in one aspect as being capable of being used as a functional material, such as a material having a high strength relative to its weight, a conductive material, and an electromagnetic wave shielding material. In a case of using the aforementioned carbon nanotube, although there is a slight difference of the volume ratio depending on the type of polymer matrix, even if at least 0.04 vol % of the carbon nanotube is dispersed, a conductive network may be formed to achieve a low volume resistivity. However large the content of carbon nanotube may be, the carbon nanotube shows high volume electric resistivity of a minimal 10 Ω-cm when only the carbon nanotube is mixed with the polymer, so that it fails to achieve the electromagnetic wave shielding effect and it is difficult to disperse the carbon nanotube throughout the polymer. As a result, the carbon nanotube is limited in being applied to a complex material such as a material for the electromagnetic wave shielding.

In order to solve this limitation, a plurality of patent applications using various mixing fillers for adding metal powders in order to increase the conductivity of the carbon nanotube have been filed. For example, Korean Patent Application Publication No. 2010-0080419 suggests a resin composition which contains a fiber filler, such as thermoplastic resin and glass fiber and a carbon-based filler, such as carbon nanotube, and is usable for the high performance electromagnetic wave interference shielding. However, the glass fiber is not a glass fiber coated with the carbon nanotube and does not contain graphite, so there is no difference in the material characteristic.

Furthermore, Korean Patent Application Publication No. 2010-0058342 introduced plastic moldings fabricated of a conductive resin composition containing a carbon compound of a thermoplastic resin, a surface-reformed carbon nanotube, and graphite to shield the electromagnetic waves. In addition, most patent applications obtain metal-carbon nanotube by a method of coating the prepared carbon nanotube with metal again or adding metal to the prepared carbon nanotube. However, the metal-carbon nanotube obtained through the aforementioned method has the problem of degradation of the metal attachment stability and also requires an additional coating or addition process.

Furthermore, electromagnetic waves are waves in which electric waves and magnetic waves coexist, and a material having a high dielectric constant and excellent conductivity is necessary for the electric field shielding and a metal with a high permeability is useful for the magnetic field shielding. In particular, in order to shield the low frequency electromagnetic waves of about 500 MHz or less required in a vehicle, a metal material having a high permeability is important. In other words, it is necessary to select a suitable material to improve the electromagnetic wave shielding property within the range of an applied frequency. Due to the special characteristics required for the material, it is difficult to shield electromagnetic waves using only one kind of material, and thus there is an emerging need for the development of a hybrid material. Furthermore, there is also a need for a method of structuralizing materials so that the properties of the materials can be well expressed.

### SUMMARY OF THE DISCLOSURE

In order to solve the aforementioned problems of the prior art, research on a method of maximizing a shielding performance through improving an electromagnetic wave shielding performance from a low frequency range to a high frequency range and efficiently removing heat generated according to the absorption of the electromagnetic wave was conducted. As a result, the inventors of the present invention discovered that a glass fiber coated with a carbon nanotube has conductivity, maintains the property of a polymer, and also serves as a competitive filler enabling graphite with a micro size to be easily dispersed, thus satisfying both property and functionality requirement.

Accordingly, an aspect of the present invention is to provide a polymer nanocomposite in which a glass fiber coated with a metal-carbon nanotube is hybridized with graphite having a nano thickness.

Accordingly, an aspect of the present invention is to provide a polymer nanocomposite material that has the properties of a polymer, while simultaneously providing excellent electromagnetic wave shielding and heat conduction properties.

In one aspect, the present invention provides a polymer nanocomposite material obtained by hybridizing a metal-carbon nanotube coated glass fiber with graphite having a nano thickness.

In another aspect, the present invention provides a method of preparing a polymer nanocomposite, including: synthesizing a catalytic metal mixed metal-carbon nanotube; melt mixing the metal-carbon nanotube and a matrix polymer to prepare a metal-carbon nanotube mixture; coating a glass fiber with the metal-carbon nanotube mixture; compounding graphite to the glass fiber to prepare a compounded mixture; and preparing a nanocomposite material by hybridizing the compounded mixture with a compression mold.

According to the present invention, it is possible to prepare the polymer nanocomposite material that induces the effective dispersion within the matrix resin and the simultaneous formation of the network by coating the glass fiber with the metal-carbon nanotube, and improves the electromagnetic wave shielding property, the heat conduction property, and the mechanical strength by simultaneously adding the graphite having the excellent heat conductivity.

Furthermore, the polymer nanocomposite material according to the present invention can be applied to various fields, such as, for example, a housing of an electric control unit (ECU) of a car, a component of an electric car, and a housing of a mobile phone and a display device, requiring the electromagnetic wave shielding and the heat conduction property.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 is a graph illustrating results of the measurement of electromagnetic wave shielding performance of a polymer nanocomposite; and

FIG. 2 is a view illustrating a carbon nanotube containing a catalytic metal.

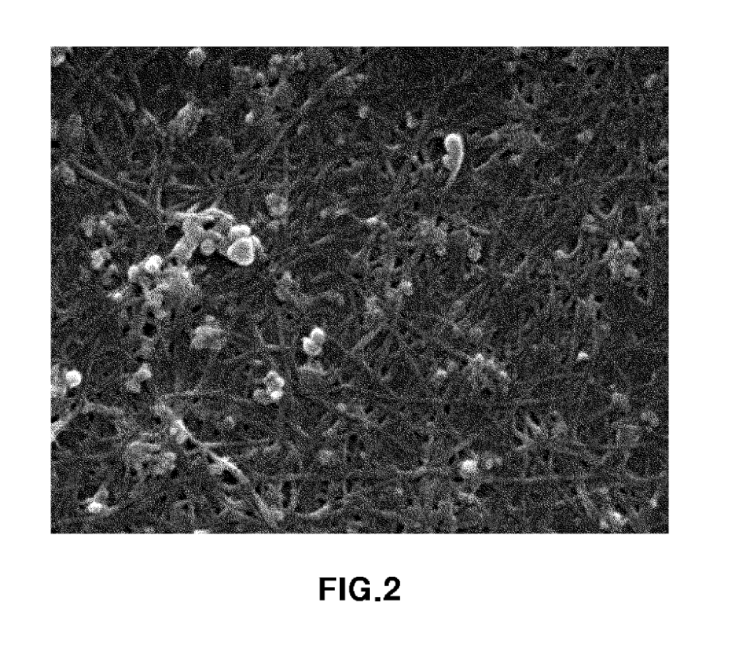

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

In one aspect, the present invention is characterized by a polymer nanocomposite obtained by hybridizing a fiber glass coated with a metal-carbon nanotube with graphite having a nano thickness.

A carbon nanotube containing a catalytic metal during synthesis may be used as the metal-carbon nanotube. The catalytic metal used in this case is preferably any one of a carbon nanotube, which is a conductive material having a good shielding property, and Fe, Co, and Ni having a high magnetic permeability for absorption of a magnetic field, or a mixture thereof. In particular, the present invention does not employ a method of coating the carbon nanotube with metal or adding metal to the carbon nanotube, but rather uses the metal served as a catalyst in the process of synthesizing the carbon nanotube, as it is without removal of the metal. In a general method of synthesizing the carbon nanotube according to an aspect of the invention, a catalyst in which Fe, Ni, and Co are mixed in a predetermined ratio, and the catalyst is removed by heat treatment at a high temperature, thereby obtaining the carbon nanotube having a high purity. In one embodiment, the present invention uses a metal-carbon nanotube containing a catalyst in which only amorphous carbon particles generated during the synthesis are removed without the removal of the metal.

In an exemplary embodiment, it is preferable that the metal-carbon nanotube is at least one nanotube selected from the group consisting of a Single Walled Carbon nanotube (SWNT), a Double Walled Carbon nanotube (DWNT), and a Multi Walled Carbon nanotube (MWNT). In a preferred embodiment, the metal-carbon nanotube has a diameter ranging from 1 to 200 nm and a length ranging from 1 to 200 μm.

The glass fiber may use a glass fiber having a diameter of 5 to 50 μm and having a length of 1 to 15 mm. It is contemplated within the scope of the invention that the shape of the cross section does not affect the contact surface with a counterpart filler and/or the improve the dispersion effect. However, but it is preferable that a size of a shorter side of the glass fiber is identical to, or smaller than, a size of graphite in comparison to the size of the glass fiber and the size of graphite to be mixed. Further, it is preferable that a quantity of metal-carbon nanotube coated on the glass fiber ranges from about 0.1 to about 10 wt %. The glass fiber is coated with the metal-carbon nanotube because the carbon nanotube has difficulty in being dispersed in a polymer, and the dispersion of the metal-carbon nanotube is increased due to the heavy metal particles so that the carbon nanotube is easily united in the polymer. Accordingly, in order to form the network with a small quantity of carbon nanotube, the carbon nanotube may be coated on the fiber to prepare a conductive filler with a micro unit. Furthermore, a carbon fiber may be used instead of the used glass fiber, but, if the carbon nanotube is coated on the glass fiber, the entire surface of the glass fiber has the conductivity, so that the carbon nanotube coated glass fiber may replace the carbon fiber incurring high unit cost.

A graphite formed into a sheet having a predetermined nano thickness is a material that has excellent heat transfer properties when graphene having a heat transfer value of 200 to 300 W/mK is disposed in a thickness of four to seven layers, and the graphite may have a thickness of 10 to 100 nm and a length of 5 to 50 μm. In this case, when the graphite has a thickness smaller than 10 nm, it creates a large processing expense for the separation from the graphite powder, and when the graphite has a thickness larger than 100 nm, the added weight ratio disadvantageously increases without an increase in the heat transfer properties. Further, when the graphite has a length shorter than 5 μm, the length of the filler for the heat transfer is short, so that the graphite begins to have a size smaller than a diameter of the glass fiber; additionally, the conductivity is decreased, thereby decreasing the dispersion effect.

In a preferred embodiment, the polymer nanocomposite has the electromagnetic wave measuring range of 0.15 MHz to 2.5 GHz.

The polymer nanocomposite according to the present invention is prepared by a method including the steps of: synthesizing a catalytic metal mixed metal-carbon nanotube; preparing a metal-carbon nanotube mixture through melting-mixing the metal-carbon nanotube and a matrix polymer; coating a glass fiber with the metal-carbon nanotube mixture; preparing a mixture through compounding graphite to the prepared glass fiber; and preparing a nanocomposite through hybridizing the compounded mixture with a compression mold.

In an exemplary embodiment, an added quantity of the catalytic metal is 10 to 50 wt % based on the carbon nanotube which is the same as the general synthesis reaction, because if the carbon nanotube has an insufficiently short diameter and a long length, the carbon nanotube is dispersed in a bent shape, so that the carbon nanotube is difficult to orient lengthwise in a glass fiber after the coating, and if the carbon nanotube has a long diameter and a short length, the aspect ratio is small, so that the contact between the fillers is difficult.

The quantity of added metal-carbon nanotube may be 0.1 to 20 wt %. When the quantity of added metal-carbon nanotube is less than 0.1 wt %, it is difficult to expect the improvement of the shielding property by the addition of the carbon nanotube, and when the quantity of added metal-carbon nanotube is larger than 20 wt %, the volume of the added carbon nanotube increases, so that the carbon nanotube is dispersed on the entire surface of the polymer matrix and cannot be effectively coated on the fiber glass.

The matrix polymer uses a thermoplastic resin, and the thermoplastic resin may use one of, but is not limited to, polyethylene, polypropylene, polystyrene, polyalkylene terephthalate, polyamide resin, polyacetal resin, polycarbonate, polysulphone, and polyimide, or a mixture thereof. The thermoplastic resin, which is a crystallizable thermoplastic resin, has the characteristic of occupying a crystalline area of the polymer in the crystallization to push the filler out of the crystalline area, so that it advantageously forms a conductive passage compared to a non-crystalline resin.

In the step of coating the glass fiber with the metal-carbon nanotube mixture, the carbon nanotube coating solution is obtained by putting a metal-carbon nanotube coating solution that is the metal-carbon nanotube mixture into a solvent and dispersing the metal-carbon nanotube by performing a general ultrasonication, to obtain a coating solution. A dispersion solvent uses a solvent having a low boiling point, such as an alcohol type including, but not limited to, ethanol, propanol, and butanol, and acetone, to be easily dried. In an exemplary embodiment, a carbon nanotube coating solution having a surface coating quantity of the carbon nanotube coating solution of 0.1 to 10 wt % is used. A surface coating quantity of the metal-carbon nanotube is preferably 0.1 to 10 wt %. A dispersant including, but not limited to, sodium dodecyl sulfate (SDS), sodium dodecylbenzenesulfonate (SDBS), or setrimonium bromide (CTAB) may be used as a dispersant that is capable of being removed through a post-processing step. Further, in order to improve the attachment of the carbon nanotube with the glass fiber, a small quantity of a binder may be added to the solution for use.

Further, in the step of preparing the mixture by compounding the metal-carbon nanotube coated glass fiber and graphite, the metal-carbon nanotube coated glass fiber and the graphite are preferably mixed in a volume ratio of 4:6 to 1:9. It is preferable to entirely form the network between the fillers by mixing the plate-shaped graphite with the glass fiber and making the glass fibers be overlapped between the graphite sheets.

In the compounding of the graphite having a nano thickness and the metal-carbon nanotube coated glass fiber, the melting temperature may be varied depending on the type of thermoplastic resin. It is preferable to use the compounded mixture having a melt-mixing temperature ranging from 180° C. to 300° C., and when the melt mixing temperature is lower than 180° C., the matrix polymer is not sufficiently melted so the fillers may not be regularly mixed, and when the melt mixing temperature is higher than 300° C., strand break of the polymer is accelerated, thereby degrading the mechanical properties of the nanocomposite.

The nanocomposite obtained by hybridizing the compounded mixture with the compression mold may additionally contain various additives, such as, for example, an antioxidant, a colorant, a mold release, and a light stabilizer, and the quantity of the additive may be appropriately controlled and applied according to various factors including the desired final use and properties. Furthermore, the hybrid nanocomposite containing the carbon nanotube having the excellent heat conductivity as well as the excellent electrical conductivity and the graphite having the excellent electrical conductivity and a nano-unit thickness may easily absorb the magnetic waves by a magnetic metal contained in the carbon nanotube, thereby improving the electromagnetic wave shielding performance.

Hereinafter, the present invention will be described based on an exemplary embodiment in more detail, but the present invention is not limited to the exemplary embodiment.

### Embodiment: Preparation of a Hybrid Composite of Metal Carbon Nanotube and Graphite

A glass fiber was coated with a carbon nanotube to prepare a conductive particle shaped like a fiber in a micro unit as described below. The glass fiber was impregnated in a carbon nanotube dispersion solution containing a Fe catalyst for 0.5 to 10 minutes depending on the desired thickness, taken out of the carbon nanotube dispersion solution, and dried in an oven for use. The drying temperature was equal to or higher than a boiling point according to a solvent used and the glass fiber was sufficiently dried for at least 60 minutes.

The glass fiber coated with 5 wt % of the SWNT (with a diameter of 2 nm and a length of 5 to 8 μm) containing the Fe catalyst and the graphite (with an average thickness of 40 nm and a size of 20 μm) was prepared in a volume ratio of 7:3 such that the resultant compounded mixture contains 8 wt % of the filler based on the total weight of the compounded mixture, and regularly mixed using a Haake Extruder mixer at a melting temperature of 230° C. and a speed of 100 rpm. The matrix used polypropylene as the thermoplastic polymer. The obtained pallet-type compounded material was prepared as a nanocomposite having a thickness of 3 mm by using a compression mold. Electromagnetic waves of the prepared composite were measured using an electromagnetic wave shielding measuring instrument (E 8362B Aglient).

### COMPARATIVE EXAMPLE 1

### Preparation of a Hybrid Composite of Carbon Nanotube and Graphite

Polypropylene was used as the thermoplastic polymer. The glass fiber coated with 5 wt % of the SWNT (with a diameter of 2 nm and a length of 5 to 8 μm) containing no catalyst and the graphite (with an average thickness of 40 nm and a size of 20 μm) were prepared in a volume ratio of 7:3 such that the resultant compounded mixture contains 8 wt % of the filler based on the total weight of the compounded mixture, and regularly mixed using a Haake Extruder mixer at a melting temperature of 230° C. and a speed of 100 rpm. The obtained pallet-type compounded material was prepared as a nanocomposite having a thickness of 3 mm by using a compression mold. Electromagnetic waves of the prepared composite were measured using an electromagnetic wave shielding measuring instrument (E 8362B Aglient).

### COMPARATIVE EXAMPLE 2

### Preparation of a Carbon Nanotube Composite

Polypropylene was used as the thermoplastic polymer. 8 wt % of the SWNT (with a diameter of 2 nm and a length of 5 to 8 μm) was mixed using a Haake Extruder mixer at a melting temperature of 230° C. and a speed of 100 rpm. The obtained pallet-type compounded material was prepared as a nanocomposite having a thickness of 3 mm by using a compression mold. Electromagnetic waves of the prepared composite were measured using the electromagnetic wave shielding measuring instrument (E 8362B Aglient).

### EXPERIMENTAL EXAMPLE

### Results of an Electromagnetic Wave Shielding Property of the Composites Prepared in the Embodiment and the Comparative Examples 1 and 2

Electromagnetic waves of the composites prepared in the embodiment and the comparative examples 1 and 2 were measured by using the electromagnetic wave shielding measuring instrument (E 8362B Aglient), and the measurement results are represented in Table 1.

TABLE 1

| | Embodiment: | Comparative | |
|---|---|---|---|
| | Fe-carbon | example 1: Carbon | Comparative |
| | nanotube + | nanotube + graphite | example 2: |
| | graphite having | having nano | Carbon |
| Test item | nano thickness | thickness | nanotube |
| Electromagnetic | 37.5 | 32 | 25 |
| wave shielding | | | |
| property | | | |
| (dB @ 1 × 10⁸ Hz) | | | |

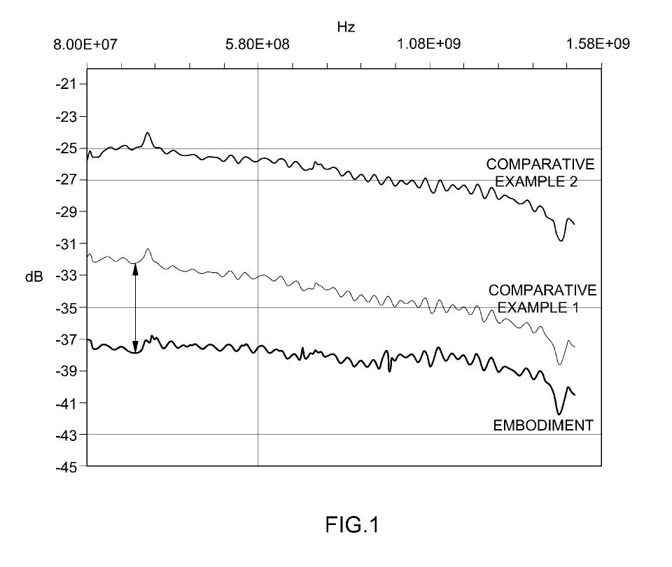

As shown in Table 1 and FIG. 1, the electromagnetic wave shielding property in a low frequency in the exemplary embodiment is high compared to comparative example 1. It can be recognized that when the same volume of fillers are added, the composite including metal displays a better electromagnetic wave shielding property in a low frequency than the composite exclusively using the carbon nanotube. Furthermore, the composite according to the embodiment has the increased electromagnetic wave shielding property compared to comparative example 2, so that it can be identified that the filler having the good heat conductivity is necessary.

Accordingly, it can be identified that the polymer nanocomposite obtained by coating the glass fiber with the metal-carbon nanotube and mixing the metal-carbon nanotube coated glass fiber with the graphite may be prepared as a composite having an excellent mechanical property and electromagnetic wave shielding property in a general region of a low frequency and high frequency, and used to fabricate moldings having the excellent property and functionality with a small content of nano particles, so that the polymer nanocomposite may be applied to various places requiring the electromagnetic wave shielding and the heat conductivity.

What is claimed is:

1. A polymer nanocomposite material comprising a glass fiber coated with a metal-carbon nanotube and graphite having a predetermined nanometer thickness.

2. The polymer nanocomposite of claim 1, wherein the metal-carbon nanotube is a carbon nanotube containing a catalytic metal.

3. The polymer nanocomposite of claim 2, wherein the catalytic metal is selected from the group consisting of Fe, Co, and Ni, and any mixture thereof.

4. The polymer nanocomposite of claim 1, wherein the metal-carbon nanotube is selected from the group consisting of a single walled carbon nanotube (SWNT), a double walled carbon nanotube (DWNT), a multi walled carbon nanotube (MWNT), and any combination thereof.

5. The polymer nanocomposite of claim 1, wherein the metal-carbon nanotube has a diameter ranging from 1 nm to 200 nm and a length ranging from 1 μm to 200 μm.

6. The polymer nanocomposite of claim 1, wherein the glass fiber has a diameter ranging from 5 to 50 μm and a length ranging from 1 to 15 mm.

7. The polymer nanocomposite of claim 1, wherein the glass fiber is coated with 0.1 to 10 wt % of the metal-carbon nanotube.

8. The polymer nanocomposite of claim 1, wherein the graphite has a thickness ranging from 10 nm to 100 nm and a length ranging from 5 μm to 50 μm.

9. The polymer nanocomposite of claim 1, wherein the polymer nanocomposite has an electromagnetic measuring wave range of 0.15 MHz to 2.5 GHz.

10. A method of preparing a polymer nanocomposite, comprising:
synthesizing a catalytic metal mixed metal-carbon nanotube;
melt-mixing the metal-carbon nanotube and a matrix polymer to prepare a metal-carbon nanotube mixture;
coating a glass fiber with the metal-carbon nanotube mixture;
compounding graphite to the glass fiber to prepare a compounded mixture; and
hybridizing the compounded mixture by using a compression mold, thereby preparing a polymer nanocomposite.

11. The method of claim 10, wherein the catalytic metal is added by 10 to 50 wt % based on the carbon nanotube.

12. The method of claim 10, wherein the metal-carbon nanotube mixture contains an added quantity of the metal-carbon nanotube of 0.1 to 20 wt %.

13. The method of claim 10, wherein the matrix polymer is selected from the group consisting of polyethylene, polypropylene, polystyrene, polyalkylene terephthalate, polyamide resin, polyacetal resin, polycarbonate, polysulphone, and polyimide, and any mixture thereof.

14. The method of claim 10, wherein a surface coating quantity of the metal-carbon nanotube is 0.1 to 10 wt %.

15. The method of claim 10, wherein the graphite and the metal-carbon nanotube coated glass fiber are mixed in a volume ratio of 4:6 to 1:9.

16. The method of claim 10, wherein the compounded mixture has a melt temperature ranging from 180° C. to 300° C.
